(19) United States
(12) Patent Application Publication
(10) Pub. No.: US 2023/0022912 A1
(43) Pub. Date: Jan. 26, 2023

(54) MOTOR

(71) Applicant: LG INNOTEK CO., LTD., Seoul (KR)

(72) Inventors: Joon Keun WOO, Seoul (KR); Sung Joo OH, Seoul (KR)

(21) Appl. No.: 17/757,900

(22) PCT Filed: Dec. 23, 2020
(86) PCT No.: PCT/KR2020/018992

§ 371 Date: Jun. 23, 2022

(30) Foreign Application Priority Data
Dec. 23, 2019 (KR) 10-2019-0173171
Dec. 23, 2019 (KR) 10-2019-0173179

(51) Int. Cl. H02K 16/02; H02K 1/278

(52) U.S. Cl. CPC H02K 16/02; H02K 1/278; B62D 5/04

(57) ABSTRACT

The present invention may provide a motor including a shaft, a rotor coupled to the shaft, and a stator disposed to correspond to the rotor, wherein the rotor includes a first rotor core and a second rotor core arranged in an axial direction, a first magnet disposed on an outer circumferential surface of the first rotor core, a second magnet disposed on an outer circumferential surface of the second rotor core, a first cover disposed outside the first magnet, and a second cover disposed outside the second magnet, a spacer is disposed between the first rotor core and the second rotor core, an end of the first cover and an end of the second cover are disposed with a gap therebetween in the axial direction, and a thickness of the spacer in the axial direction is greater than or at least equal to a size of the gap so that the first magnet and the second magnet do not overlap the gap in a radial direction.

### TECHNICAL FIELD

The present invention relates to a motor.

### BACKGROUND ART

An electric power steering (EPS) system is an apparatus which secures turning stability of a vehicle and rapidly provides a restoring force so that a driver can safely drive the vehicle. An EPS system controls a vehicle's steering shaft to be driven by driving a motor using an electronic control unit (ECU) according to driving conditions detected by a vehicle speed sensor, a torque angle sensor, a torque sensor, and the like.

A motor includes a stator and a rotor. The rotor includes a rotor core and magnets disposed on an outer surface of the rotor core. In addition, the rotor may include a cover surrounding the rotor core and the magnets. The cover may be a can member formed of a metal material. The cover may include one side cover installed at one side of the rotor core and another side cover installed at the other side of the rotor core. The cover including the two parts is bound to form a gap between an end of the one side cover and an end of the other side cover.

Accordingly, there is a problem that the magnets and the core which are disposed inside the motor are exposed to the outside through the gap. In addition, there are problems that foreign matters are introduced through the gap, and the foreign matters or oxides flow down along the gap and contaminate the motor.

### DISCLOSURE

### Technical Problem

The present invention is directed to providing a motor in which formation of a gap between one side cover and another side cover is prevented to prevent magnets from being exposed to the outside.

Objectives to be solved by the present invention are not limited to the above-described objectives, and other objectives which are not described above will be clearly understood by those skilled in the art through following descriptions.

### Technical Solution

One aspect of the present invention provides a motor including a shaft, a rotor coupled to the shaft, and a stator disposed to correspond to the rotor, wherein the rotor includes a first rotor core and a second rotor core arranged in an axial direction, a first magnet disposed on an outer circumferential surface of the first rotor core, a second magnet disposed on an outer circumferential surface of the second rotor core, a first cover disposed outside the first magnet, and a second cover disposed outside the second magnet, a spacer is disposed between the first rotor core and the second rotor core, an end of the first cover and an end of the second cover are disposed with a gap therebetween in the axial direction, and a thickness of the spacer in the axial direction is greater than or at least equal to a size of the gap so that the first magnet and the second magnet do not overlap the gap in a radial direction.

Another aspect of the present invention provides a motor including a shaft, a rotor coupled to the shaft, and a stator disposed to correspond to the rotor, wherein the rotor includes a first rotor core and a second rotor core arranged in an axial direction, a first magnet disposed on an outer circumferential surface of the first rotor core, a second magnet disposed on an outer circumferential surface of the second rotor core, a first cover disposed outside the first magnet, and a second cover disposed outside the second magnet, a spacer is disposed between the first rotor core and the second rotor core, the first cover includes a first extension portion protruding further than one end of the first magnet in the axial direction, the second cover includes a second extension portion protruding further than one end of the second magnet in the axial direction, the first extension portion is disposed apart from the second extension portion in the axial direction, and the first extension portion and the second extension portion are disposed to overlap the spacer in a radial direction.

Still another aspect of the present invention provides a motor including a shaft, a rotor coupled to the shaft, and a stator disposed to correspond to the rotor, wherein the rotor includes a first outer circumferential surface, a second outer circumferential surface, and a third outer circumferential surface which are sequentially disposed in an axial direction to form an outermost side thereof, an outer diameter of the second outer circumferential surface is smaller than an outer diameter of the first outer circumferential surface and an outer diameter of the third outer circumferential surface, a part of the second outer circumferential surface is disposed to overlap the first outer circumferential surface and the third outer circumferential surface in a radial direction, and a material of the second outer circumferential surface is different from a material of any one of the first and third outer circumferential surfaces.

An end of the first cover and an end of the second cover may be disposed to overlap the spacer in the radial direction.

In the radial direction, the first extension portion may be disposed apart from the spacer, and the second extension portion may be disposed apart from the spacer.

An outer diameter of the spacer may be smaller than a maximum distance from a center of the shaft to an outer surface of the magnet and greater than a minimum distance from the center of the shaft to the outer surface of the magnet.

Each of the first rotor core and the second rotor core may include a first hole through which the shaft passes, the spacer may include a second hole at a center thereof, and an inner diameter of the second hole may be greater than an inner diameter of the first hole.

The spacer may include a first surface and a second surface disposed opposite to each other, the first surface may be in contact with one end surface of the first magnet, and the second surface may be in contact with one end surface of the second magnet.

Each of a boundary between the first surface and an outer circumferential surface of the spacer and a boundary between the second surface and the outer circumferential surface of the spacer may be any one of a curved surface and an inclined surface.

The spacer may include a first part, a second part, and a third part divided in the axial direction, the second part may be disposed at one side of the first part and in contact with the first rotor core, the third part may be disposed at the other side of the first part and in contact with the second rotor core, an outer diameter of the first part may be greater than an outer diameter of the second part and an outer diameter of the third part, and an inner diameter of the first cover may be smaller than an inner diameter of the second cover.

Yet another aspect of the present invention provides a motor including a shaft, a rotor coupled to the shaft, a stator disposed outside the rotor, and a housing disposed outside the stator, wherein the rotor includes a rotor core, a plurality of magnets disposed on an outer circumferential surface of the rotor core, and a can disposed outside the plurality of magnets, the can includes a first member and a second member disposed in an axial direction, and an end portion of the second member is disposed in the first member.

An end portion of the first member and an end portion of the second member may overlap in a radial direction, and a sum of a length of the first member and a length of the second member in the axial direction may be greater than a length of the rotor core in the axial direction.

The first member may include a first part having a cylindrical shape and a second part protruding from an end portion of the first part and having a greater diameter than the first part.

The second part may be spaced apart from the magnets in a radial direction, the end portion of the second member may be disposed between the second part and the magnets in the radial direction, and a separation distance between the second part and each of the magnets may be greater than a thickness of the second member.

A length of the second member may be greater than a length of the first part in the axial direction.

A ratio of the length of the second member in the axial direction to the length of the first part in the axial direction may be in a range of 0.4 to 0.6.

A second part disposed between and connected to the first part and the second part may be formed, and an end portion of the third part may be spaced apart from the end portion of the second member.

The second part may include a first region which does not overlap the first member and a second region which overlaps the first member, and a length of the second region in the axial direction may change according to a length of the rotor core in the axial direction.

A first inclined surface which is inclined toward one side may be formed on the end portion of the first member, and a second inclined surface which is inclined toward one side opposite to the inclination of the first inclined surface may be formed on the end portion of the second member.

The first inclined surface may be disposed inward, and the second inclined surface may be disposed outward.

A length of the first member in the axial direction may increase outward, and the length of the second member in the axial direction may increase inward.

The first inclined surface may have a first inclination angle, the second inclined surface may have a second inclination angle, and the first inclination angle may be equal to the second inclination angle.

The end portion of the first member may be spaced apart from the end portion of the second member in the radial direction, and an adhesive may be disposed between the first member and the second member.

### Advantageous Effects

According to embodiments, there is an advantage in that exposure of magnets to the outside is prevented by a spacer.

According to the embodiments, since a gap between covers is removed, there is an advantage in that foreign matters are prevented from being introduced into a motor, or the foreign matters or oxides are prevented from flowing down.

According to the embodiments, although two covers are used, since the gap between the covers is removed, there are advantages in that a cover installation process is easy, and a manufacturing cost of the covers is reduced when compared to a single cover.

According to the embodiments, the present invention can be applied to rotors having various sizes by adjusting a length of a can in an axial direction.

### DESCRIPTION OF DRAWINGS

FIG. 1 is a view illustrating a motor according to a first embodiment.

FIG. 2 is an exploded view illustrating a rotor illustrated in FIG. 1.

FIG. 3 is a side cross-sectional view illustrating the rotor.

FIG. 4 is a front view illustrating the rotor.

FIG. 5 is a side cross-sectional view illustrating a cover and a spacer.

FIG. 6 is a plan view illustrating magnets and a rotor core to illustrate a range of an outer diameter of the spacer.

FIG. 7 is a plan view illustrating the rotor when the spacer has a minimum outer diameter.

FIG. 8 is a plan view illustrating the rotor when the spacer has a maximum outer diameter.

FIG. 9 is a view illustrating a modified example of a spacer including a curved surface.

FIG. 10 is a view illustrating another modified example of a spacer including regions having different outer diameters.

FIG. 11 is a perspective view illustrating a rotor of a motor according to a second embodiment.

FIG. 12 is an exploded perspective view illustrating the rotor illustrated in FIG.

FIG. 13 is a cross-sectional view along line AA′ of the rotor.

FIG. 14 is a cross-sectional view illustrating a rotor according to a modified example.

FIG. 15 is an enlarged view illustrating a first end portion and a second end portion.

FIG. 16 is a cross-sectional view illustrating a can.

FIG. 17 is an enlarged view illustrating the first end portion and the second end portion illustrated in FIG. 16.

FIG. 18 is a view illustrating a state in which an adhesive is applied on that in FIG. 17.

FIG. 19 is a cross-sectional view illustrating a rotor according to another modified example.

### MODES OF THE INVENTION

A direction parallel to a longitudinal direction (vertical direction) of a shaft will be referred to as an axial direction, a direction perpendicular to the axial direction through the shaft will be referred to as a radial direction, and a direction along a circumference of a circle having a radius in the radial direction through the shaft will be referred to as a circumferential direction.

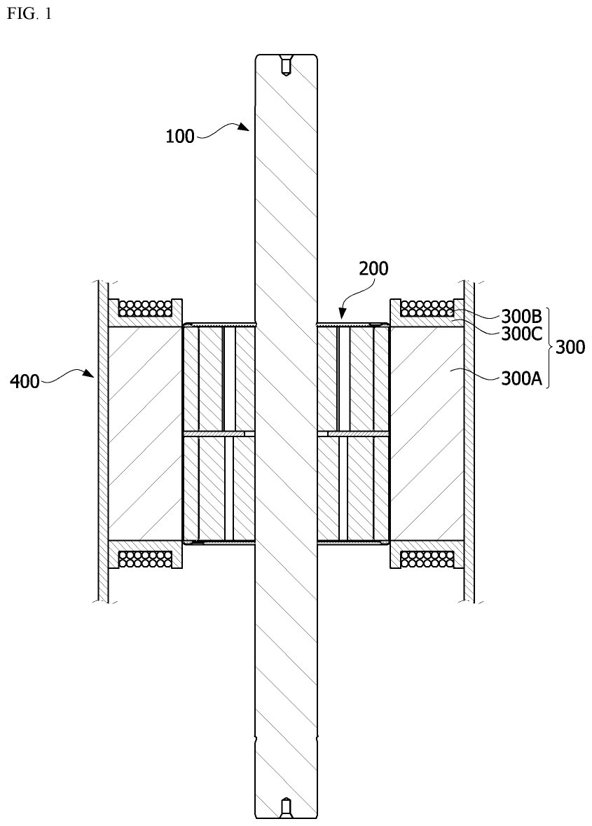

FIG. 1 is a view illustrating a motor according to an embodiment.

Referring to FIG. 1, the motor according to the embodiment may include a shaft 100, a rotor 200, a stator 300, and a housing 400. Hereinafter, the term “inward” refers to a direction from the housing 400 toward the shaft 100 which is located at a center of the motor, and the term “outward” refers to a direction opposite to “inward,” that is, a direction from the shaft 100 toward the housing 400.

The shaft 100 may be coupled to the rotor 200. When an electromagnetic interaction occurs between the rotor 200 and the stator 300 due to the supply of a current, the rotor 200 rotates, and the shaft 100 rotates in conjunction with the rotor 200. The shaft 100 may be connected to a vehicle's steering system, and power may be transmitted to the vehicle's steering system through the shaft 100.

The rotor 200 rotates through an electrical interaction with the stator 300. The rotor 200 may be disposed inside the stator 300.

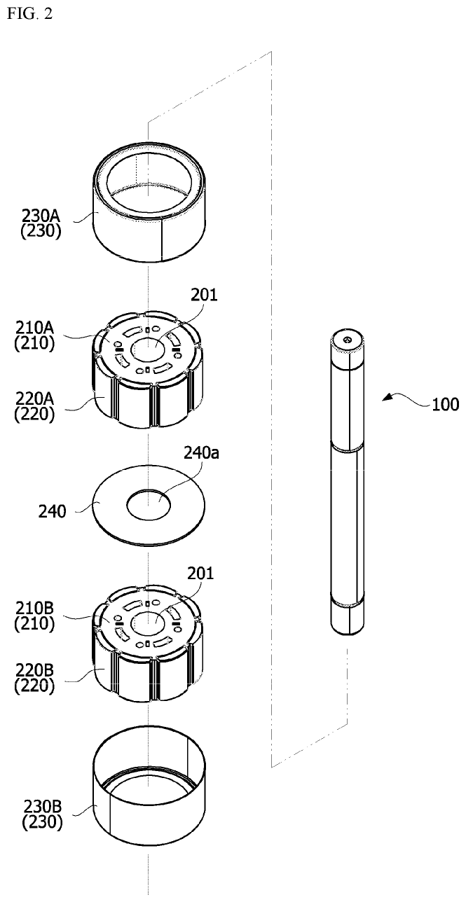

The stator 300 is disposed outside the rotor 200. The stator 300 may include a stator core 300A, coils 300B, and an insulator 300C installed on the stator core 300A. The coils 300B may be wound around the insulator 300C. The insulator 300C is disposed between the coils 300B and the stator core 300A to electrically insulate the stator core 300A from the coils 300B. The coils 300B induce an electrical interaction with magnets 220 (see FIG. 2) of the rotor 200.

The housing 400 may be disposed outside the rotor 200 and the stator 300.

FIG. 2 is an exploded view illustrating the rotor 200 illustrated in FIG. 1.

Referring to FIG. 2, the rotor 200 may include a rotor core 210, the magnets 220, covers 230, and a spacer 240. The magnets 220 are disposed outside the rotor core 210. The covers 230 are disposed outside the rotor core 210 and the magnets 220. The covers 230 may be can members formed of a metal material. The spacer 240 may be formed of a plastic resin. The magnets 220 may be formed by combining a plurality of unit magnets 220.

The rotor core 210 may include a first rotor core 210A and a second rotor core 210B. The first rotor core 210A and the second rotor core 210B are arranged in an axial direction. The first rotor core 210A and the second rotor core 210B may be disposed to have a skew angle. First holes 201 through which the shaft 100 passes are disposed in the first rotor core 210A and the second rotor core 210B. The magnets 220 may be divided into first magnets 220 and second magnets 220. The first magnets 220 are disposed on an outer surface of the first rotor core 210A. The second magnets 220 are disposed on an outer surface of the second rotor core 210B. The covers 230 may include a first cover 230A and a second cover 230B. The first cover 230A is disposed to surround the first rotor core 210A and the first magnets 220A. The second cover 230B is disposed to surround the second rotor core 210B and the second magnets 220B. The first cover 230A is installed at one side of the rotor core 210 in the axial direction, and the second cover 230B is installed at the other side of the rotor core 210.

The spacer 240 may be disposed between the first rotor core 210A and the second rotor core 210B in the axial direction. The spacer 240 may be an annular-shaped flat member in which a second hole 240a is formed, wherein the shaft 100 passes through the second hole 240a.

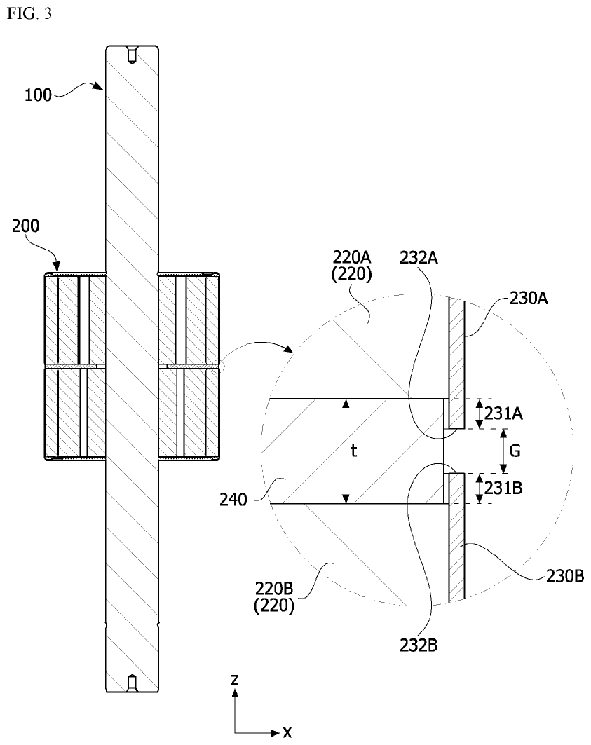

FIG. 3 is a side cross-sectional view illustrating the rotor 200.

Referring to FIG. 3, a gap G is formed between an end 232A of the first cover 230A and an end 232B of the second cover 230B in the axial direction. The spacer 240 is positioned between the first rotor core 210A and the second rotor core 210B so that the magnets 220 are not exposed to the outside through the gap G.

The spacer 240 is disposed to be aligned with the gap G in the axial direction. A thickness t of the spacer 240 in the axial direction determines a position of one end of each of the magnets 220 in contact with the spacer 240. Accordingly, when seen in a radial direction, the thickness t of the spacer 240 in the axial direction should be greater than or equal to a size of the gap G so that the gap G does not overlap the magnet 220. Accordingly, the end 232A of the first cover 230A and the end 232B of the second cover 230B in the radial direction are disposed to overlap the spacer 240 in the axial direction.

The first cover 230A may include a first extension portion 231A. The first extension portion 231A is a portion protruding further than one end of the first magnet 220A in the axial direction. The second cover 230B may include a second extension portion 231B. The second extension portion 231B is a portion protruding further than one end of the second magnet 220B in the axial direction.

The first extension portion 231A and the second extension portion 231B are disposed apart from each other by the gap G in the axial direction. The first extension portion 231A and the second extension portion 231B are positioned to overlap the spacer 240 when seen in the radial direction. Accordingly, the magnet 220 is not exposed to the outside through the gap G. Meanwhile, the first extension portion 231A and the spacer 240 may be disposed apart from each other in the radial direction. In addition, the second extension portion 231B and the spacer 240 may also be disposed apart from each other in the radial direction. This is for preventing the ends 232A and 232B of the covers 230 from being hooked on the spacer 240 when the cover 230 is installed on the rotor core 210.

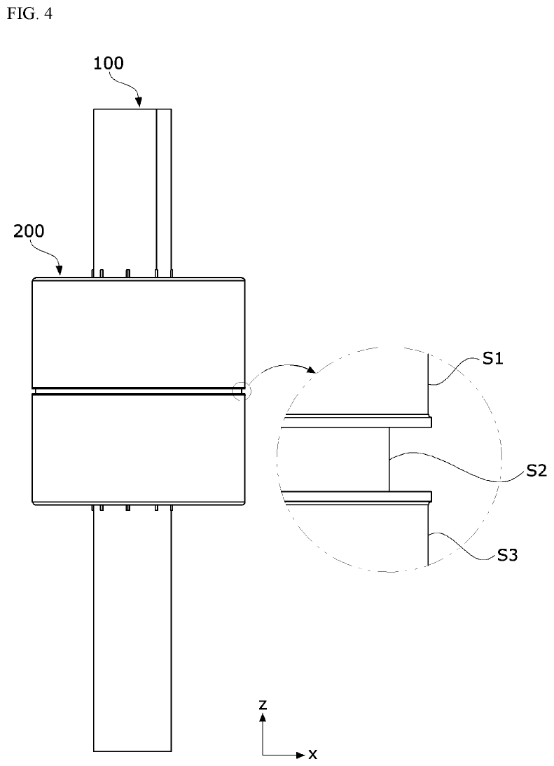

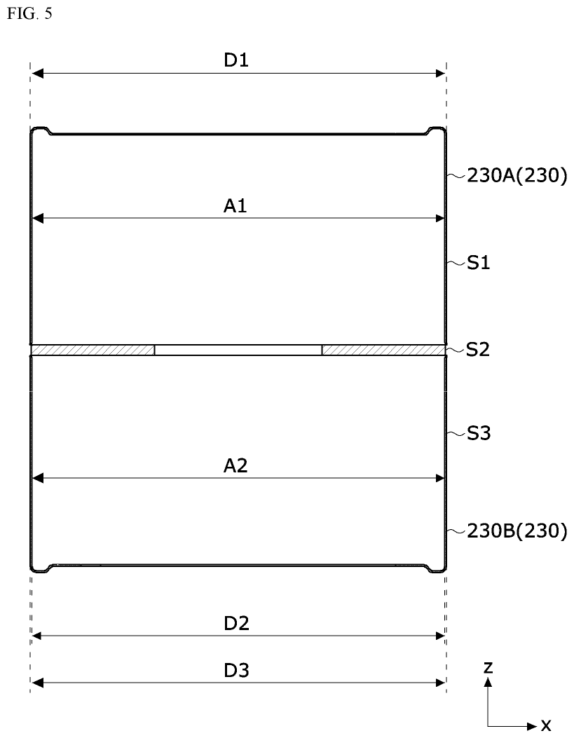

FIG. 4 is a front view illustrating the rotor 200, and FIG. 5 is a side cross-sectional view illustrating the covers 230 and the spacer 240.

Referring to FIGS. 4 and 5, the rotor 200 may include a first outer circumferential surface S1, a second outer circumferential surface S2, and a third outer circumferential surface S3 which are sequentially disposed in the axial direction to form an outermost side of the rotor 200. The first outer circumferential surface S1 may correspond to an outer circumferential surface of the first cover 230A. The second outer circumferential surface S2 may correspond to an outer circumferential surface of the spacer 240. The third outer circumferential surface S3 may correspond to an outer circumferential surface of the second cover 230B. The first outer circumferential surface S1 and the third outer circumferential surface S3 may be formed of metal materials, and the second outer circumferential surface S2 may be formed of a plastic material.

The second outer circumferential surface S2 has a stepped shape with respect to the first outer circumferential surface S1 and the third outer circumferential surface S3.

An outer diameter of the first outer circumferential surface S1 is equal to an outer diameter of the third outer circumferential surface S3. An outer diameter D2 of the second outer circumferential surface S2 is smaller than an outer diameter D1 of the first outer circumferential surface S1 or an outer diameter D3 of the third outer circumferential surface S3. In addition, a part of one side of the second outer circumferential surface S2 may be disposed to overlap the first outer circumferential surface S1 in the radial direction. In addition, a part of the other side of the second outer circumferential surface S2 may be disposed to overlap the third outer circumferential surface S3 in the radial direction.

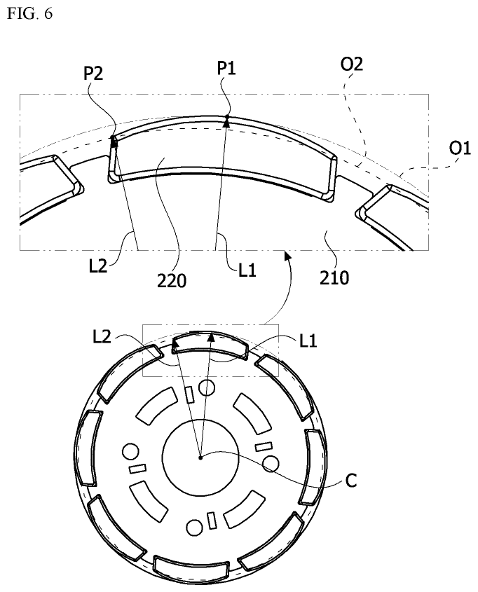

FIG. 6 is a plan view illustrating the magnets 220 and the rotor core 210 to illustrate a range of the outer diameter D1 of the spacer 240.

Referring to FIG. 6, the outer diameter D1 of the spacer 240 may correspond to a diameter of a circular orbit present between a first circular orbit O1 and a second circular orbit O2 about a center C of the rotor 200 in the radial direction. In this case, a radius of the first circular orbit O1 corresponds to a maximum distance L1 from the center C of the rotor 200 to an outer surface of the magnet 220, and a radius of the second circular orbit O2 corresponds to a minimum distance from the center of the rotor 200 to the outer surface of the magnet 220. The maximum distance L1 from the center C of the rotor 200 to the outer surface of the magnet 220 may be a straight distance from the center C of the rotor 200 to a width center P1 of the outer surface of the magnet 220 in a circumferential direction. A minimum distance L2 from the center C of the rotor 200 to the outer surface of the magnet 220 may be a straight distance from the center C of the rotor 200 to the end 232A of the outer surface of the magnet 220.

The range of an outer diameter of the spacer 240 corresponds to a size of the spacer 240 so that the spacer 240 is not interfered with when the cover 230 is installed on the rotor core 210, the magnet 220 is not exposed to the outside through the gap G, and foreign matters are not introduced into the rotor 200.

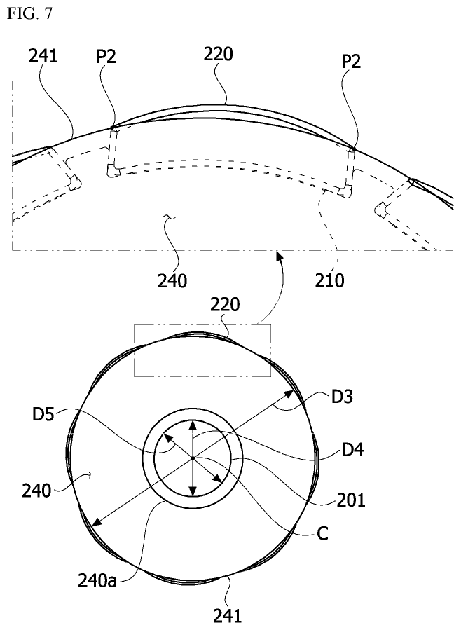

FIG. 7 is a plan view illustrating the rotor 200 when the spacer 240 has a minimum outer diameter D1.

Referring to FIG. 7, when the spacer 240 has a minimum outer diameter D3, that is, an outer circumferential surface 241 of the spacer 240 is disposed to pass through an end P2 of the outer surface of the magnet 220, the spacer 240 covers most of one side end of the magnet 220 and allows a part of an outermost side of the magnet 220 to be exposed when seen in the axial direction. In this state, the magnet 220 is not exposed to the outside through the gap G, and when the cover 230 is installed on the rotor core 210, the spacer 240 is not interfered with at all.

Meanwhile, the second hole 240a is disposed in a central portion of the spacer 240. The second hole 240a is a hole through which the shaft 100 passes. In this case, an inner diameter D7 of the second hole 240a may be greater than an inner diameter D5 of the first hole 201 of the rotor core 210.

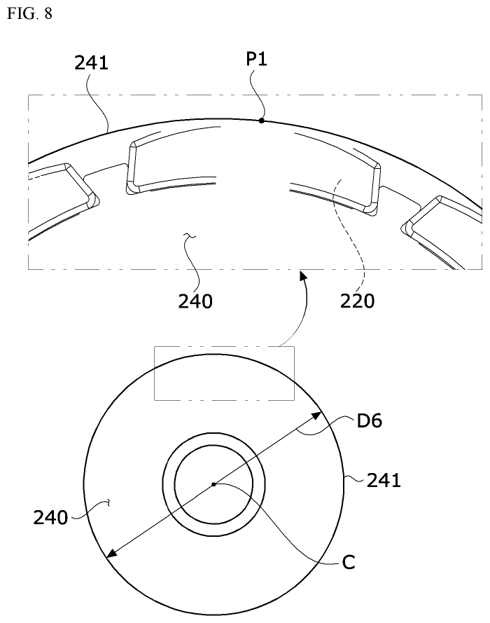

FIG. 8 is a plan view illustrating the rotor 200 when the spacer 240 has a maximum outer diameter D1.

Referring to FIG. 8, when the spacer 240 has a maximum outer diameter D6, that is, the outer circumferential surface 241 of the spacer 240 is disposed to pass through the width center P1 of the outer surface of the magnet 220 in the circumferential direction, the spacer 240 covers an entirety of the magnet 220 when seen in the axial direction. In this state, the magnet 220 is not exposed to the outside at all through the gap G. When the cover 230 is installed on the rotor core 210, inner circumferential surfaces of the covers 230 may be inserted along the outer circumferential surface of the spacer 240. Accordingly, the inner circumferential surfaces of the covers 230 may be in contact with the outer circumferential surface of the spacer 240.

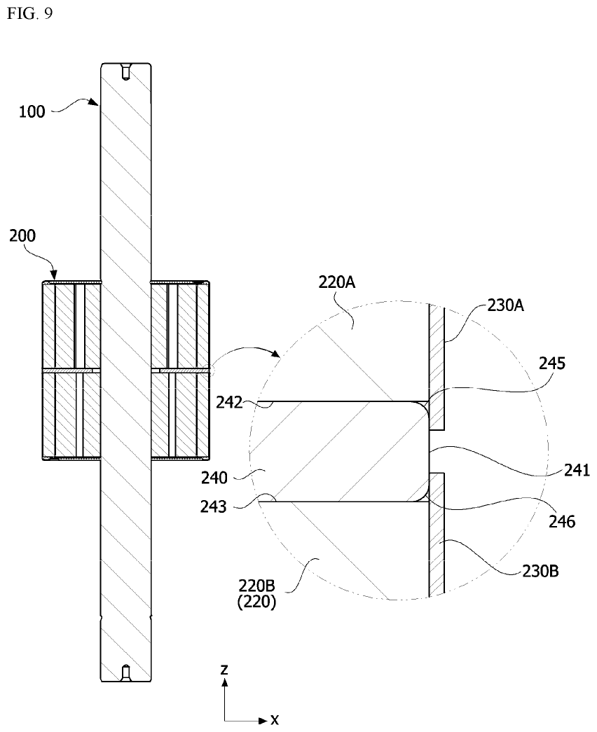

FIG. 9 is a view illustrating a modified example of a spacer 240 including a curved surface.

Referring to FIG. 9, the spacer 240 may include a first surface 242 and a second surface 243 opposite to each other. The first surface 242 is in contact with one end surface of a first magnet 220A. In addition, the second surface 243 is in contact with one end surface of a second magnet 220B.

A boundary between the first surface 242 and an outer circumferential surface 241 of the spacer 240 may be a curved surface 245 or inclined surface.

A boundary between the second surface 243 and the outer circumferential surface 241 of the spacer 240 may be a curved surface 246 or inclined surface.

The curved surface 245 of the spacer 240 maximally blocks exposure of the magnet 220 due to the gap G and guides the outer circumferential surface 241 of the spacer 240 not to be hooked on the cover 230 when the cover 230 is installed on the rotor core 210.

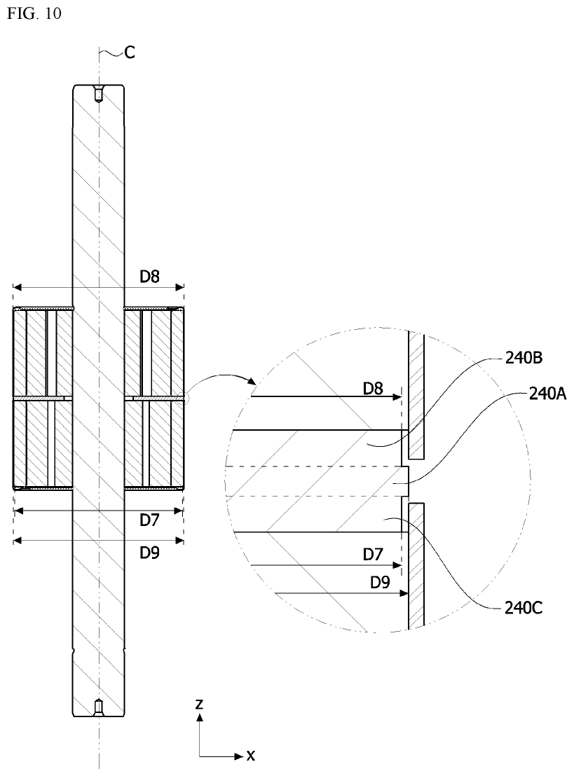

FIG. 10 is a view illustrating another modified example of a spacer including regions having different outer diameters.

Referring to FIG. 10, a spacer 240 may include regions having different outer diameters. For example, the spacer 240 may include a first part 240A, a second part 240B, and a third part 240C divided in an axial direction. The second part 240B is a part in contact with a first rotor core 210AA. The third part 240C is a part in contact with a second rotor core 210B. The first part 240A is disposed between the first rotor core 210A and the third rotor core 210 in the axial direction.

An outer diameter D7 of the first part 240A may be greater than an outer diameter D8 of the second part 240B and an outer diameter D9 of the third part 240C. Accordingly, the spacer 240 has a shape in which an outer circumferential surface of the first part 240A protrudes further than an outer circumferential surface of the second part 240B and an outer circumferential surface of the third part 240C. In addition, the outer diameter D7 of the first part 240A is smaller than an inner diameter of the first cover 230A and an inner diameter of the second cover 230B.

The spacer 240 having such a structure also maximally blocks exposure of the magnet 220 due to a gap G and guides an outer circumferential surface 241 of the spacer 240 not to be hooked on covers 230 when the covers 230 are installed on a rotor core 210.

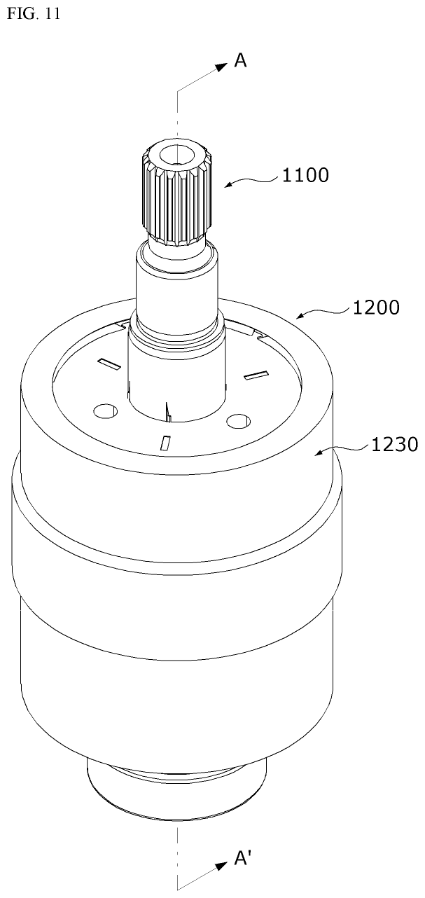

FIG. 11 is a perspective view illustrating a rotor of a motor according to a second embodiment, and FIG. 12 is an exploded perspective view illustrating the rotor illustrated in FIG. 11.

Referring to FIGS. 11 and 12, a rotor 1200 may include a rotor core 1210, a plurality of magnets 1220, and a can 1230.

The rotor core 1210 is coupled to a shaft 1100. The plurality of magnets 1220 are coupled to an outer circumferential surface of the rotor core 1210. In addition, the can 1230 is disposed outside the magnets 1220. In this case, the can 1230 fixes the magnets 1220 not to be separated from the rotor core 1210. In addition, the can 1230 prevents the magnets 1220 from being exposed and physically and chemically protects the rotor core 1210 and the magnets 1220. The can 1230 may include a first member 1231 and a second member 1232. One side of each of the rotor core 1210 and the magnets 1220 is surrounded by the first member 1231, and the other side thereof is surrounded by the second member 1232.

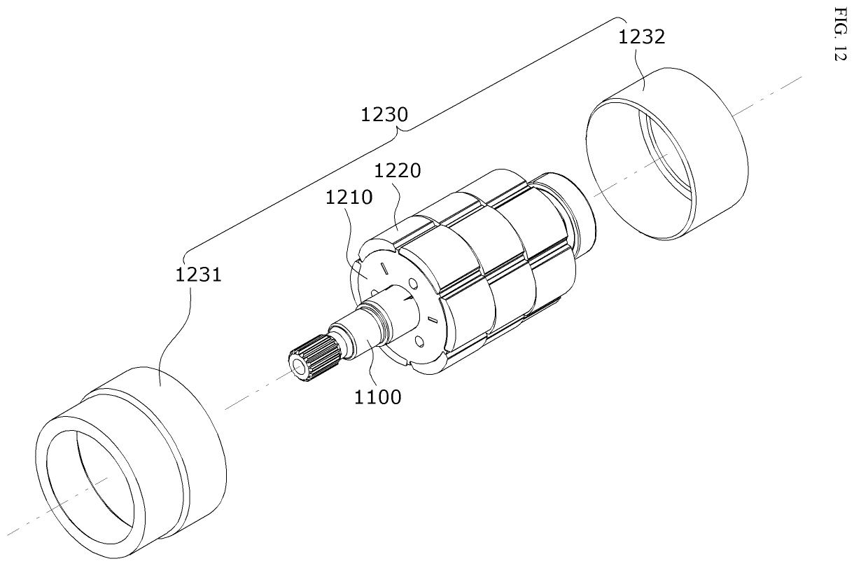

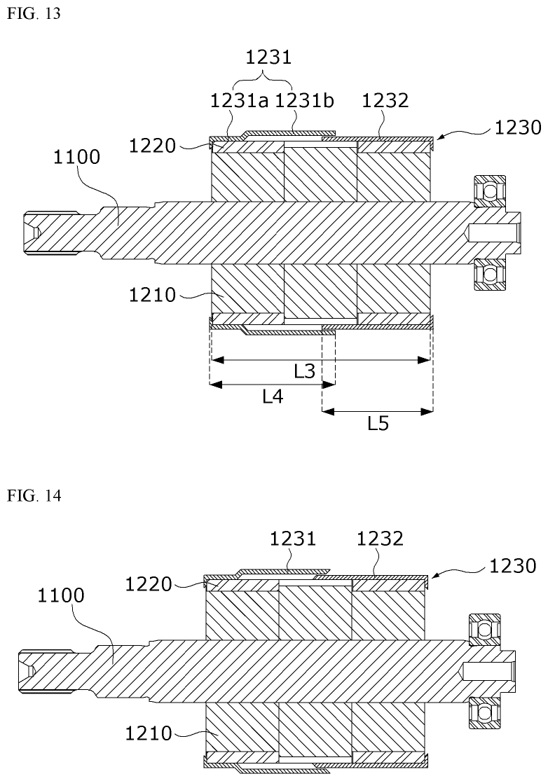

FIG. 13 is a cross-sectional view along line AA′ of the rotor 1200.

Referring to FIG. 13, the first member 1231 and the second member 1232 are disposed in an axial direction. The first member 1231 and the second member 1232 may each have a cylindrical shape having an open one side. Open portions of the first member 1231 and the second member 1232 face each other. The first member 1231 and the second member 1232 form an inner space. The rotor core 1210 and the magnets 1220 are disposed inside the first member 1231 and the second member 1232.

An end portion of the second member 1232 is inserted into the first member 1231. End portions of the first member 1231 and the second member 1232 overlap in a radial direction.

The sum of a length L4 of the first member 1231 in the axial direction and a length L5 of the second member 1232 in the axial direction is greater than a length L3 of the rotor core 1210 in the axial direction.

The first member 1231 surrounds one side of each of the rotor core 1210 and the magnets 1220. In this case, a diameter of the first member 1231 may be changed according to a position thereof in the axial direction. The diameter of the first member 1231 may increase toward the second member 1232.

The first member 1231 may include a first part 1231a and a second part 1231b having different diameters. The first part 1231a and the second part 1231b may be integrally formed.

A thickness of the end portion of the first member 1231 may be constant.

The second member 1232 surrounds the other side of the rotor 1200. The second member 1232 forms a space for accommodating the rotor 1200 therein. The second member 1232 may have a cylindrical shape. In this case, a diameter of the second member 1232 may be constant regardless of a position in the axial direction.

The end portion of the second member 1232 is inserted into the first member 1231.

A thickness of the end portion of the second member 1232 may be constant.

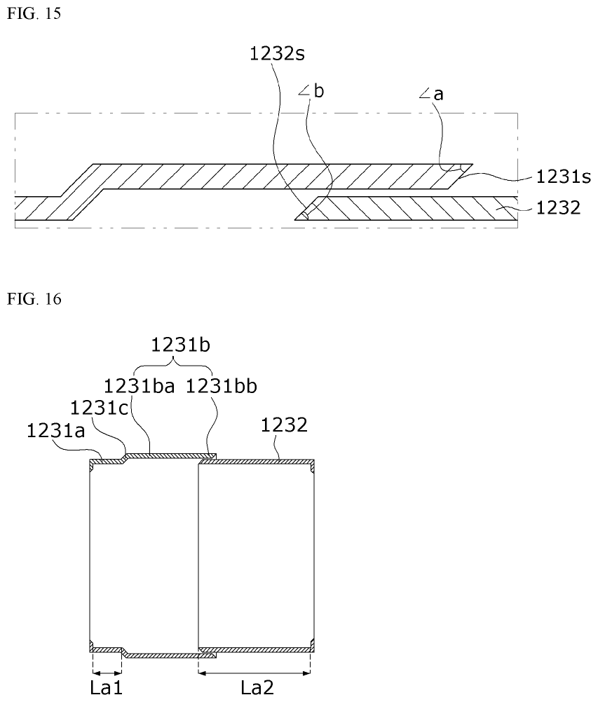

FIG. 14 is a cross-sectional view illustrating a rotor according to another embodiment, and FIG. 15 is an enlarged view illustrating a first end portion and a second end portion.

Referring to FIG. 14, an end portion of a first member 1231 may be inclined. In addition, an end portion of a second member 1232 may be inclined. In this case, an inclination of the first member 1231 and an inclination of the second member 1232 may correspond to each other. This is for preventing a hooking phenomenon while the end portion of the second member 1232 is inserted into the first member 1231.

More specifically referring to FIG. 15, a first inclined surface 1231s may be formed on the end portion of the first member 1231. The first inclined surface 1231s may be disposed inward. The first inclined surface 1231s may be disposed to face magnets 1220. In this case, a thickness of the first member 1231 decreases toward the end portion thereof. In addition, a length of the first member 1231 in an axial direction increases outward. The first inclined surface 1231s may have a first inclination angle ∠a. The first inclination angle ∠a is an angle formed by the first inclined surface 1231s with respect to the axial direction.

A second inclined surface 1232s may be formed on the end portion of the second member 1232. The second inclined surface 1232s is disposed in a direction opposite to the first inclined surface 1231s. The second inclined surface 1232s may be disposed outward. In this case, a thickness of the second member 1232 decreases toward the end portion thereof. In addition, a length of the second member 1232 in the axial direction increases inward. The second inclined surface 1232s may have a second inclination angle ∠b. The second inclination angle ∠b is an angle formed by the second inclined surface 1232s with respect to the axial direction. The first inclination angle ∠a may be equal to the second inclination angle ∠b. Meanwhile, the first inclination angle ∠a may be different from the second inclination angle ∠b.

In the present invention, while the second member 1232 is inserted into the first member 1231, even when hooking occurs on the end portions, the end portion of the second member 1232 may be guided to an inner portion of the first member 1231 by the inclination.

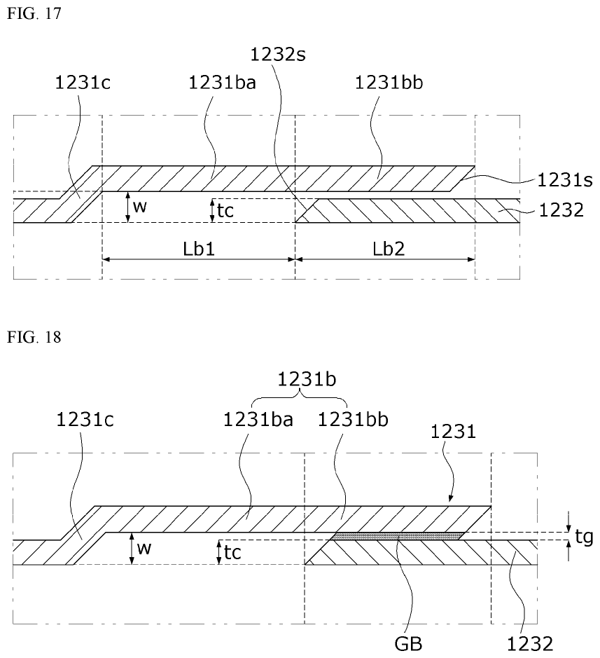

FIG. 16 is a cross-sectional view illustrating a can, and FIG. 17 is an enlarged view illustrating the first end portion and the second end portion illustrated in FIG. 16. Referring to FIG. 16, the first member 1231 includes a first part 1231a, a second part 1231b, and, a third part 1231c.

The first part 1231a may have a cylindrical shape. The first part 1231a may include a body and an upper surface. The upper surface may be bent from the body having the cylindrical shape. A hole through which a shaft passes may be formed in the upper surface. The upper surface is in contact with an upper end of a rotor core 1210. An inner circumferential surface of the body may be in contact with the magnets 1220.

The third part 1231c may be formed between the first part 1231a and the second part 1231b. A diameter of the third part 1231c may increase from a side of the first part 1231a toward the second part 1231b. In this case, the third part 1231c may diagonally connect the first part 1231a and the second part 1231b. However, although not illustrated in the drawings, the third part may also extend from an end portion of the first part in a radial direction. In this case, the third part may be vertically connected to the first part and the second part. A step is formed between the first part 1231a and the second part 1231b by the third part 1231c.

The second part 1231b extends from the third part 1231c. The second part 1231b has a cylindrical shape. A diameter of the second part 1231b may be greater than that of the first part 1231a. An inner circumferential surface of the second part 1231b may be spaced apart from each of the magnets 1220. Referring to FIG. 17, a separation distance w between the second part 1231b and the magnet 1220 is greater than a thickness tc of the second member 1232. In this case, the end portion of the second member 1232 may be disposed between the second part 1231b and the magnet 1220 in the radial direction.

The second part 1231b may include a first region 231ba and a second region 231bb. The first region 231ba and the second region 231bb are integrally formed. The first region 231ba and the second region 231bb are divided according to overlapping of the second member 1232.

The first region 231ba extends from the third part 231c. In this case, the first region 231ba is a region which does not overlap the second member 1232 in the radial direction. In addition, the second region 231bb extends from the first region 231ba. Meanwhile, the second region 231bb overlaps the second member 1232 in the radial direction. A length Lb2 of the second region 231bb in the axial direction may be smaller than a length Lb1 of the first region 231ba in the axial direction. In this case, the length Lb2 of the second region 231bb in the axial direction may be changed according to a length of the rotor core 1210 in the axial direction.

The second member 1232 may have a shape in which a lower surface is bent from a body having a cylindrical shape. A hole through which the shaft passes is formed in the lower surface. The lower surface is in contact with a lower end of the rotor core 1210. A side surface surrounds an edge of the lower surface. In this case, an inner circumferential surface of the side surface is in contact with the magnet 1220.

Further referring to FIG. 16, the length of the second member 1232 may be greater than a length of the first part 1231a in the axial direction. In this case, a ratio of a length La2 of the second member 1232 in the axial direction to a length La1 of the first part 1231a in the axial direction may be in a range of 0.4 to 0.6. For example, a ratio of the length La2 of the second member 1232 in the axial direction to the length La1 of the first part 1231a in the axial direction may be 0.5. That is, the length La2 of the second member 1232 in the axial direction may be two times greater than the length La1 of the first part 1231a in the axial direction.

FIG. 18 is a view illustrating a state in which an adhesive is applied on that in FIG. 17.

Referring to FIG. 18, the first member 1231 and the second member 1232 may be airtightly sealed using the adhesive.

The end portions of the first member 1231 and the second member 1232 overlap in the radial direction. In addition, overlapping portions of the first member 1231 and the second member 1232 are spaced apart from each other. Accordingly, a gap may be formed between a first end portion 1101 and a second end portion 1201. In the present invention, a process of inserting the second member 1232 into the first member 1231 is easy due to the gap, but there is a risk of foreign matters being introduced toward the magnets 1220 through the gap. Accordingly, the adhesive may be applied in the gap to prevent the foreign matters from being introduced. Particularly, an adhesive GB may prevent introduction of external moisture.

The adhesive GB may be disposed between the second region 231bb and the second part 1231b. In this case, the adhesive GB may be applied on an entirety of an inner surface of the second region 231bb. Alternatively, the adhesive GB may be applied on only a part of the inner surface of the second region 231bb. In this case, a thickness Tg of the adhesive GB in the axial direction is equal to a difference between the separation distance W from the first member 1231 and the magnet 1220 and the thickness Tc of the second member 1232.

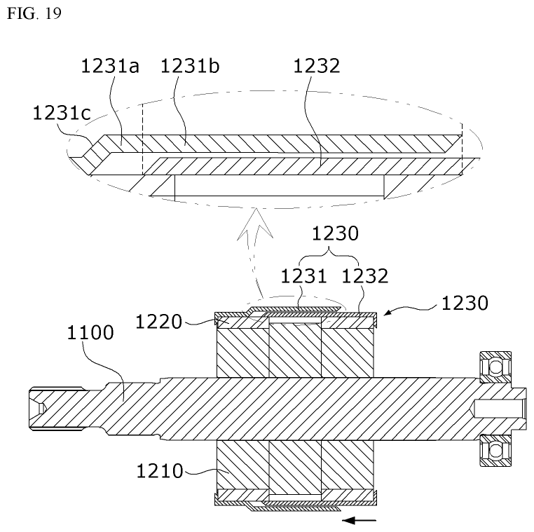

FIG. 19 is a cross-sectional view illustrating a rotor according to still another embodiment.

In a rotor according to the present embodiment, only a length of a rotor core in an axial direction is different from that illustrated in FIG. 14, and other components are substantially the same as those in FIG. 14. Accordingly, the same reference numerals are assigned to the same components as those in FIG. 14, and repeated description will be omitted.

A length of a can 1230 may be adjusted in the axial direction.

Referring to FIG. 19, the length of the can 1230 is adjusted to correspond to a length of a rotor core 1210 in the axial direction. In this case, when compared to FIG. 14, a length of a second member 1232 inserted into a first member 1232 increases. That is, a length of a second region 231bb increases. However, a length of a first region 231ba in the axial direction decreases. In addition, a distance from an end portion of the second member 1232 to a step 231c decreases. In this case, the length of the second region 231bb in the axial direction may be greater than the length of the first region 231ba in the axial direction.

As described above, when the can 1230 is applied to a rotor core having a relatively small length in the axial direction, an overlapping length of a first member 1231 and a second member 1232 may increase. However, when a rotor core having a relatively great length in the axial direction is inserted into the can 1230, an overlapping length of the first member 1231 and the second member 1232 may decrease. However, the length of the rotor core 1210 in the axial direction should be greater than a length of the first member 1231 or the second member 1232 in the axial direction and smaller than the sum of the length of the first member 1231 and the length of the second member 1232 in the axial direction.

The present invention can be applied to rotor cores having various sizes by adjusting a length of the can in the axial direction according to the length of the rotor core.

The present invention can be used in various devices for vehicles or home appliances.

We claim:

1. A motor comprising:
a shaft;
a rotor coupled to the shaft; and
a stator disposed to correspond to the rotor,
wherein the rotor includes a first rotor core and a second rotor core arranged in an axial direction, a first magnet disposed on an outer circumferential surface of the first rotor core, a second magnet disposed on an outer circumferential surface of the second rotor core, a first cover disposed outside the first magnet, and a second cover disposed outside the second magnet,
a spacer is disposed between the first rotor core and the second rotor core,
an end of the first cover and an end of the second cover are disposed with a gap therebetween in the axial direction, and
a thickness of the spacer in the axial direction is greater than or at least equal to a size of the gap so that the first magnet and the second magnet do not overlap the gap in a radial direction,
the first cover includes a first extension portion protruding further than one end of the first magnet in the axial direction,
the second cover includes a second extension portion protruding further than one end of the second magnet in the axial direction,
the first extension portion is disposed apart from the second extension portion in the axial direction, and
the first extension portion and the second extension portion are disposed to overlap the spacer in a radial direction,
In the radial direction, the first extension portion is disposed apart from the spacer, and the second extension portion is disposed apart from the spacer.

2. The motor of claim 1,
wherein an outer diameter of the spacer is smaller than a maximum distance from a center of the shaft to an outer surface of the magnet and greater than a minimum distance from the center of the shaft to the outer surface of the magnet.

3. The motor of claim 1,
wherein the rotor includes a first outer circumferential surface, a second outer circumferential surface, and a third outer circumferential surface which are sequentially disposed in an axial direction to form an outermost side thereof,
an outer diameter of the second outer circumferential surface is smaller than an outer diameter of the first outer circumferential surface and an outer diameter of the third outer circumferential surface,
a part of the second outer circumferential surface is disposed to overlap the first outer circumferential surface and the third outer circumferential surface in a radial direction, and
a material of the second outer circumferential surface is different from a material of any one of the first and third outer circumferential surfaces.

4. The motor of claim 1, wherein an end of the first cover and an end of the second cover are disposed to overlap the spacer in the radial direction.

5. The motor of claim 2, wherein, in the radial direction:
the first extension portion is disposed apart from the spacer; and
the second extension portion is disposed apart from the spacer.

6. A motor comprising:
a shaft;
a rotor coupled to the shaft;
a stator disposed outside the rotor; and
a housing disposed outside the stator,
wherein the rotor includes a rotor core, a plurality of magnets disposed on an outer circumferential surface of the rotor core, and a can disposed outside the plurality of magnets,
the can includes a first member and a second member disposed in an axial direction, and
an end portion of the second member is disposed in the first member,
wherein the first member include a first part having a cylindrical shape and a second part protruding from an end portion of the first part and a step is formed between the first part and the second part by the third part,
wherein the first part is in contact with the magnet and the second part are spaced apart from the magnet.

7. The motor of claim 6, wherein:
an end portion of the first member and an end portion of the second member overlap in a radial direction; and
a sum of a length of the first member and a length of the second member in the axial direction is greater than a length of the rotor core in the axial direction.

8. The motor of claim 6, wherein
a first inclined surface which is inclined toward one side is formed on the end portion of the first member, and a second inclined surface which is inclined toward one side opposite to the inclination of the first inclined surface is formed on the end portion of the second member.

9. The motor of claim 8,
wherein the first inclined surface is disposed inward, and the second inclined surface is disposed outward.

10. The motor of claim 9, wherein a separation distance between the second part and each of the magnets is greater than a thickness of the second member.
